(19) United States
(12) Patent Application Publication
(10) Pub. No.: US 2005/0200145 A1
(43) Pub. Date: Sep. 15, 2005

(54) Portable device for transporting a spool of cable

(76) Inventors: Andre Morin, Amqui (CA); Joel Morin, Vevise ev Que'bec (CA)

Correspondence Address: ASHKAN NAJAFI, P.A., 6817 SOUTHPOINT PARKWAY, SUITE 2301, JACKSONVILLE, FL, 32216, US

(21) Appl. No.: 10/801,028

(22) Filed: Mar. 15, 2004

(51) Int. Cl. B66C 1/54

(52) U.S. Cl. 294/97

(57) ABSTRACT

A portable device for transporting a spool of cable includes a stationary handle and a movable handle movable between raised and lowered positions. The invention further includes a housing positionable into a spool opening. The housing has pistons mounted within it and has apertures formed around the pistons. Advantageously, latching members are connected to the pistons and are movable between retracted and extended positions through a plurality of corresponding apertures as the movable handle is lowered and raised. The plurality of pistons engage a spool opening and allow an operator to lift a spool and transport it while the movable handle is at a raised position. The latching members are disengageable from a spool when the movable handle is released to a lowered position.

### CROSS REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Technical Field

This invention relates to a device for transporting a spool of cable and, more particularly, a portable device that is removably connectable to a spool of cable.

2. Prior Art

Various tools have been devised for insertion internally of a hollow element, such as a spool of cable, to grasp and lift that element. Such objects are large and heavy, which makes them very awkward to handle. Wire used in manufacturing operations, such for example as making small coiled springs, is fabricated and shipped in large coils typically weighing 1,000 pounds each. The coils are typically wound with open cores, which may include a paperboard sleeve.

Handling such coils, which are known in the trade as “reel-less cores”, is difficult. Devices for handling coils are not entirely new but their impracticality is born out by the fact that none of them is in general usage in industry today. Of the most practical ones, it may be said that they are unduly complicated and necessitated considerable time and mechanism to effect the gripping or releasing of the coil. In addition to such shortcomings, previous devices often damage the coil, thereby necessitating a repairing operation or the scrapping of the coil in whole or in part. Other prior art spool carriers designed heretofore have handles that are too small and cause finger strain due to repetitive gripping.

Accordingly, a need remains for a portable device that is removably connectable for transporting a spool of cable and, which overcomes the above-noted shortcomings.

### BRIEF SUMMARY OF THE INVENTION

In view of the foregoing background, it is therefore an object of the present invention to provide a portable device for transporting a spool of cable. These and other objects, features, and advantages of the invention are provided by a device including a stationary handle having a central portion positionable within a hand of a user and a movable handle disposed below the stationary handle that is selectively movable along a substantially vertical path between raised and lowered positions. The movable handle cooperates with the stationary handle during operating conditions. The stationary handle may have a plurality of substantially vertical grooves formed therein for guiding the movable handle therealong.

The present invention further includes a housing positionable into a spool opening and is secured to the stationary handle. The housing includes a plurality of pistons slidably mounted therein and has a plurality of spaced apertures formed about the plurality of pistons. The housing further includes an elongated fastening member secured to the plurality of pistons and to the movable handle. The fastening member may be threadably engaged with the plurality of pistons and may be disposed substantially medially thereof. The housing may further include an upper section and a lower section integral therewith. The upper and lower sections may each have a predetermined diameter.

Advantageously, a plurality of latching members are pivotally connected to the plurality of pistons respectively and are movable between retracted and extended positions through the plurality of apertures as the movable handle is lowered and raised respectively. A first set of the plurality of latching members may be diametrically spaced approximately 120 degrees apart. Similarly, a second set of the plurality of latching members may be diametrically spaced approximately 120 degrees apart. The second set of latching members may be disposed below the first set of latching members for cooperating therewith to maintain the device securely engaged with a spool of cable. The plurality of pistons engage a select portion within a spool opening and thereby allow an operator to lift a spool and transport same while the movable handle is maintained at a raised position. The plurality of latching members are disengageable from a spool when the movable handle is released to a lowered position.

### BRIEF DESCRIPTION OF THE SEVERAL VIEWS OF THE DRAWING

The novel features believed to be characteristic of this invention are set forth with particularity in the appended claims. The invention itself, however, both as to its organization and method of operation, together with further objects and advantages thereof, may best be understood by reference to the following description taken in connection with the accompanying drawings in which:

FIG. 1 is a perspective view showing a portable device attached to a spool of cable for transporting same, in accordance with the present invention;

FIG. 2 is an enlarged perspective view of the device shown in FIG. 1;

FIG. 3 is a cross-sectional view showing the device in FIG. 1 at a raised position, taken along line 3-3;

FIG. 4 is a cross-sectional view showing the device in FIG. 1 at a lowered position;

FIG. 5 is a cross-sectional view of the device shown in FIG. 1, taken along line 5-5; and

FIG. 6 is a cross-sectional view of the device shown in FIG. 1, taken along line 6-6.

### DETAILED DESCRIPTION OF THE INVENTION

The present invention will now be described more fully hereinafter with reference to the accompanying drawings, in which a preferred embodiment of the invention is shown. This invention may, however, be embodied in many different forms and should not be construed as limited to the embodiment set forth herein. Rather, this embodiment is provided so that this application will be thorough and complete, and will fully convey the true scope of the invention to those skilled in the art. Like numbers refer to like elements throughout the figures.

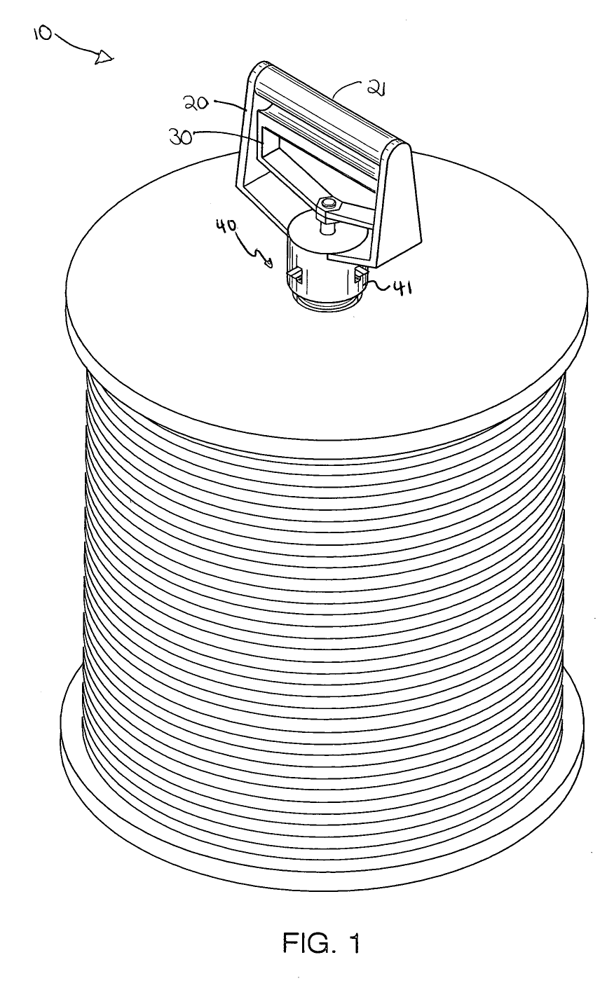

The device of this invention is referred to generally in FIGS. 1-6 by the reference numeral 10 and is intended to provide a portable device that is removably connectable to a spool of cable. It should be understood that the device 10 may be used to transport many different types of cable spools.

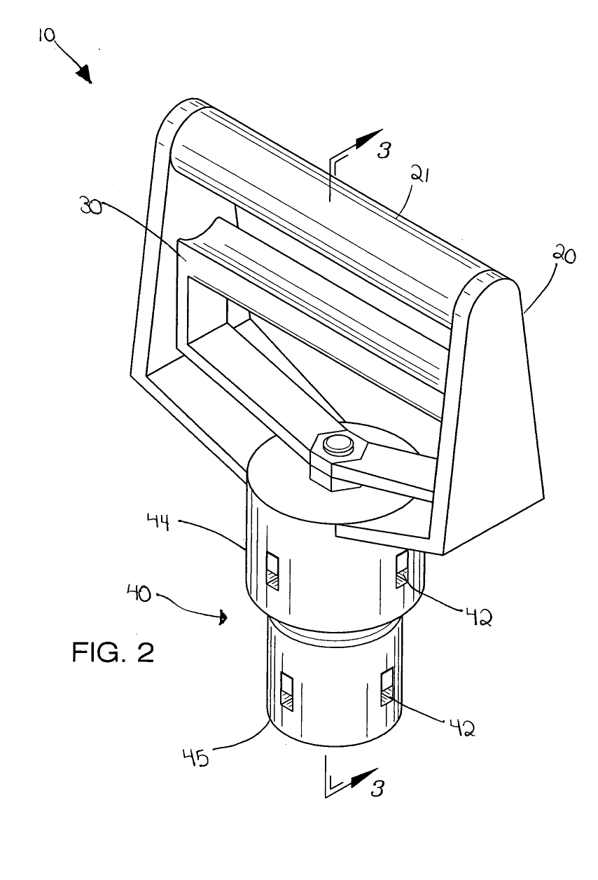

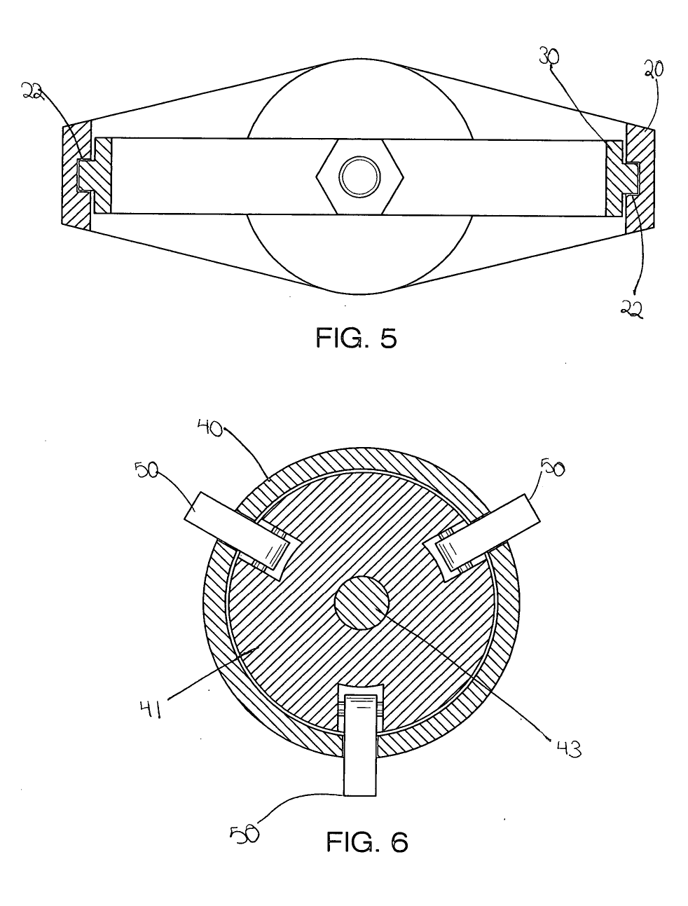

Referring initially to FIGS. 1 and 2, the device 10 includes a stationary handle 20 having a central portion 21 positionable within a hand of a user and a movable handle 30 disposed below the stationary handle 20 that is selectively movable along a substantially vertical path between raised and lowered positions. The movable handle 30 cooperates with the stationary handle 20 during operating conditions. The stationary handle 20 has a plurality of substantially vertical grooves 22 formed therein for guiding the movable handle 30 therealong, best shown in FIG. 5. In addition, the handles 20, 30 are large enough to prevent the finger strain that commonly occurs when using devices such as this.

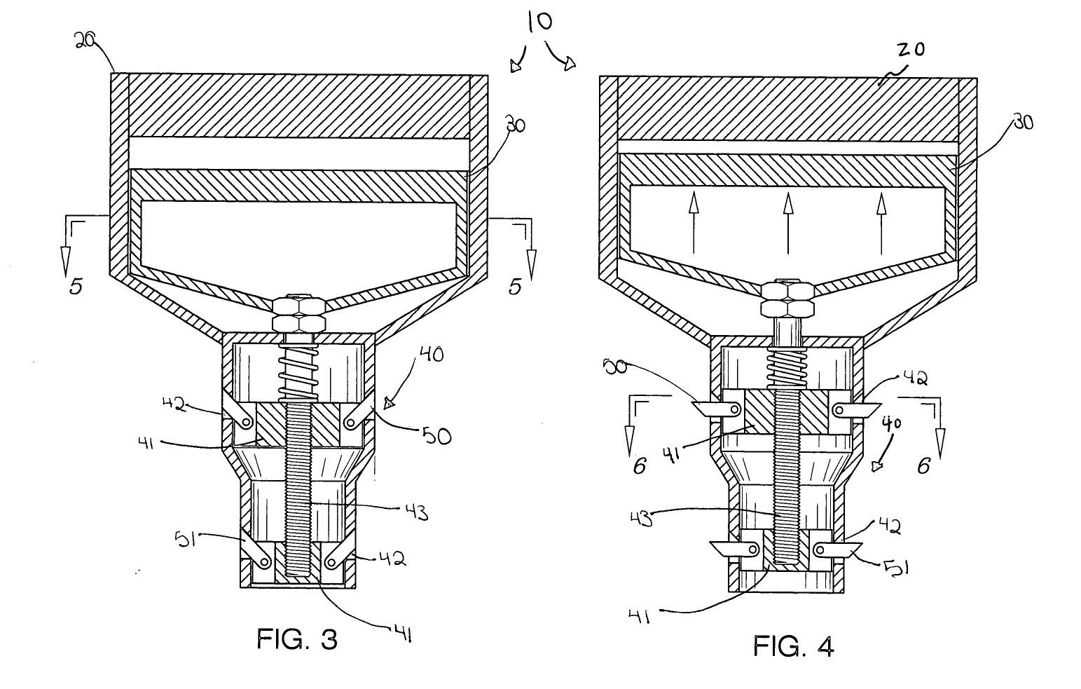

Referring to FIGS. 2 and 3, the present invention further includes a housing 40 positionable into a spool opening and is secured to the stationary handle 20. The housing 40 includes a plurality of pistons 41 slidably mounted therein and has a plurality of spaced apertures 42 formed about the plurality of pistons 41. The housing 40 further includes an elongated fastening member 43 secured to the plurality of pistons 41 and to the movable handle 30. The fastening member 43 is threadably engaged with the plurality of pistons 41 and is disposed substantially medially thereof. The housing 40 further includes an upper section 44 and a lower section 45 integral therewith. The upper 44 and lower 45 sections each have a predetermined diameter.

Referring to FIGS. 3 and 4, a plurality of latching members 50 are pivotally connected to the plurality of pistons 41 respectively and are movable between retracted and extended positions through the plurality of apertures 42 as the movable handle 30 is lowered and raised respectively. This feature is advantageous because it allows one to simply grip both handles 20, 30 at the same time and easily transport a spool to the desired location. As shown in FIG. 6, a first set of the plurality of latching members 50 are diametrically spaced approximately 120 degrees apart.

Similarly, a second set of the plurality of latching members 51 are diametrically spaced approximately 120 degrees apart. The second set of latching members 51 are disposed below the first set of latching members 50 for cooperating therewith to maintain the device 10 securely engaged with a spool of cable. The plurality of pistons 41 engage a select portion within a spool opening and thereby allow an operator to lift a spool and transport same while the movable handle 30 is maintained at a raised position. The plurality of latching members 50, 51 are disengageable from a spool when the movable handle 30 is released to a lowered position.

Contractors and electricians might find using this invention to be an essential part of their workday. In addition to being easy to operate, the present invention may be designed to be compact. This feature allows it to be conveniently stored in a pouch or holster attached to a work belt. To have such a necessary tool within reach is ideal for the work site.

While the invention has been described with respect to a certain specific embodiment, it will be appreciated that many modifications and changes may be made by those skilled in the art without departing from the spirit of the invention. It is intended, therefore, by the appended claims to cover all such modifications and changes as fall within the true spirit and scope of the invention.

In particular, with respect to the above description, it is to be realized that the optimum dimensional relationships for the parts of the present invention may include variations in size, materials, shape, form, function and manner of operation. The assembly and use of the present invention are deemed readily apparent and obvious to one skilled in the art.

1. A transporting device removably connectable to a spool of cable, said device comprising:
a stationary handle including a central portion positionable within a hand of a user;
a movable handle disposed below said stationary handle and being selectively movable along a substantially vertical path between raised and lowered positions, said movable handle cooperating with said stationary handle during operating conditions;
a housing positionable into a spool opening and being secured to said stationary handle, said housing including a plurality of pistons slidably mounted therein and having a plurality of spaced apertures formed about said plurality of pistons, said housing further including an elongated fastening member secured to said plurality of pistons and to said movable handle; and
a plurality of latching members pivotally connected to said plurality of pistons respectively and being movable between retracted and extended positions through said plurality of apertures as said movable handle is lowered and raised respectively, said plurality of pistons for engaging a select portion within a spool opening and thereby allowing an operator to lift a spool and transport same while said movable handle is maintained at a raised position, said plurality of latching members being disengageable from a spool when said movable handle is released to a lowered position.

2. The device of claim 1, wherein said housing further comprises:
an upper section and a lower section integral therewith, said upper and lower sections each having a predetermined diameter.

3. The device of claim 1, wherein a first set of said plurality of latching members are diametrically spaced approximately 120 degrees apart.

4. The device of claim 3, wherein a second set of said plurality of latching members are diametrically spaced approximately 120 degrees apart, said second set of latching members being disposed below said first set of latching members and for cooperating therewith to maintain said device securely engaged with a spool of cable.

5. The device of claim 1, wherein said fastening member is threadably engaged with said plurality of pistons and is disposed substantially medially thereof.

6. The device of claim 1, wherein said stationary handle has a plurality of substantially vertical grooves formed therein and for guiding said movable handle therealong.

7. A transporting device removably connectable to a spool of cable, said device comprising:
a stationary handle including a central portion positionable within a hand of a user;
a movable handle disposed below said stationary handle and being selectively movable along a substantially vertical path between raised and lowered positions, said movable handle cooperating with said stationary handle during operating conditions;
a housing positionable into a spool opening and being secured to said stationary handle, said housing including a plurality of pistons slidably mounted therein and having a plurality of spaced apertures formed about said plurality of pistons, said housing further including an elongated fastening member secured to said plurality of pistons and to said movable handle; and
a plurality of latching members pivotally connected to said plurality of pistons respectively and being movable between retracted and extended positions through said plurality of apertures as said movable handle is lowered and raised respectively, said plurality of pistons for engaging a select portion within a spool opening and thereby allowing an operator to lift a spool and transport same while said movable handle is maintained at a raised position, said plurality of latching members being disengageable from a spool when said movable handle is released to a lowered position, said housing further comprising an upper section and a lower section integral therewith, said upper and lower sections each having a predetermined diameter.

8. The device of claim 7, wherein a first set of said plurality of latching members are diametrically spaced approximately 120 degrees apart.

9. The device of claim 8, wherein a second set of said plurality of latching members are diametrically spaced approximately 120 degrees apart, said second set of latching members being disposed below said first set of latching members and for cooperating therewith to maintain said device securely engaged with a spool of cable.

10. The device of claim 7, wherein said fastening member is threadably engaged with said plurality of pistons and is disposed substantially medially thereof.

11. The device of claim 7, wherein said stationary handle has a plurality of substantially vertical grooves formed therein and for guiding said movable handle therealong.

12. A transporting device removably connectable to a spool of cable, said device comprising:
a stationary handle including a central portion positionable within a hand of a user;
a movable handle disposed below said stationary handle and being selectively movable along a substantially vertical path between raised and lowered positions, said movable handle cooperating with said stationary handle during operating conditions;
a housing positionable into a spool opening and being secured to said stationary handle, said housing including a plurality of pistons slidably mounted therein and having a plurality of spaced apertures formed about said plurality of pistons, said housing further including an elongated fastening member secured to said plurality of pistons and to said movable handle; and
a plurality of latching members pivotally connected to said plurality of pistons respectively and being movable between retracted and extended positions through said plurality of apertures as said movable handle is lowered and raised respectively, said plurality of pistons for engaging a select portion within a spool opening and thereby allowing an operator to lift a spool and transport same while said movable handle is maintained at a raised position, said plurality of latching members being disengageable from a spool when said movable handle is released to a lowered position, said housing further comprising an upper section and a lower section integral therewith, said upper and lower sections each having a predetermined diameter;
a first set of said plurality of latching members being diametrically spaced approximately 120 degrees apart.

13. The device of claim 12, wherein a second set of said plurality of latching members are diametrically spaced approximately 120 degrees apart, said second set of latching members being disposed below said first set of latching members and for cooperating therewith to maintain said device securely engaged with a spool of cable.

14. The device of claim 12, wherein said fastening member is threadably engaged with said plurality of pistons and is disposed substantially medially thereof.

15. The device of claim 12, wherein said stationary handle has a plurality of substantially vertical grooves formed therein and for guiding said movable handle therealong.
